(19) United States
(12) Patent Application Publication
(10) Pub. No.: US 2026/0143434 A1
(43) Pub. Date: May 21, 2026

(54) WIRELESS COMMUNICATION SYSTEM, CENTRALIZED STATION, CENTRALIZED CONTROL METHOD AND CENTRALIZED CONTROL PROGRAM

(71) Applicants: NTT, Inc., Tokyo (JP); NTT DOCOMO, INC., Tokyo (JP)

(72) Inventors: Hayato FUKUZONO, Musashino-shi, Tokyo (JP); Toshifumi MIYAGI, Musashino-shi, Tokyo (JP); Takeshi ONIZAWA, Musashino-shi, Tokyo (JP); Tatsuki OKUYAMA, Tokyo (JP); Satoshi SUYAMA, Tokyo (JP); Yoshihisa KISHIYAMA, Tokyo (JP)

(73) Assignees: NTT, Inc., Tokyo (JP); NTT DOCOMO, INC., Tokyo (JP)

(21) Appl. No.: 19/114,468

(22) PCT Filed: Sep. 27, 2022
(86) PCT No.: PCT/JP2022/035988

§ 371 Date: Mar. 24, 2025

(51) Int. Cl. H04W 52/34; H02J 50/00; H02J 50/20; H04B 7/0452; H04W 16/28; H04W 64/00; H04W 72/0457

(52) U.S. Cl. CPC H04W 52/34; H02J 50/001; H02J 50/20; H04B 7/0452; H04W 16/28; H04W 64/00; H04W 72/0457

(57) ABSTRACT

A wireless communication system according to one embodiment: collects terminal position information indicating a position of each of a plurality of terminals, power intensity information indicating an intensity of received power, and residual amount information indicating a residual amount of stored power of a storage battery of each of the terminals; calculates allocated power with respect to each of the terminals of the base station based on the collected terminal position information, the power intensity information, and the residual amount information; calculates a parameter that optimizes bandwidth allocation and power use efficiency with respect to each of the terminals of the base station so as to minimize power consumption while raising the power use efficiency of the entire system; and controls use efficiency of transmitted power of an RF signal transmitted by each of the base stations to each of the terminals according to the parameter.

### TECHNICAL FIELD

The present invention relates to a wireless communication system, a centralized station, a centralized control method, and a centralized control program.

### BACKGROUND ART

Conventionally, techniques are known which achieve, in a multi-user MIMO (Multiple Input Multiple Output) system, both data transmission and energy harvesting by RF (Radio Frequency) signals by grouping, respectively, a plurality of terminals that perform wireless communication and a plurality of terminals that perform charging (for example, refer to NPL 1).

### CITATION LIST

### Non Patent Literature

[NPL 1] J. Rubio and A. P. Iserte, “User grouping and resource allocation in multiuser MIMO systems under SWIPT,” EURASIP Journal on Wireless Communications and Networking 2019.

### SUMMARY OF THE INVENTION

### Problem to be Solved by the Invention

However, conventionally, there were cases where power consumption of base stations in multiuser MIMO systems could not be reduced and use efficiency of power of the entire system could not be sufficiently raised.

The present invention has been made in consideration of the problem described above and an object thereof is to provide a wireless communication system, a centralized station, a centralized control method, and a centralized control program that enable use efficiency of power of the entire wireless communication system to be optimized while achieving both data transmission and energy harvesting by RF signals.

### Solution to Problem

A wireless communication system according to one embodiment of the present invention is a wireless communication system comprising a centralized station which centrally controls a plurality of base stations that can each accommodate a plurality of terminals, the pluralities of terminals and base stations engaging in multi-user MIMO wireless communication, wherein each terminal includes: an information decoder which decodes information to be data from an RF signal received from each base station; an energy harvester which performs a charge of a storage battery by energy harvesting using the RF signal received from the base station; and a switching unit which performs switching so that the RF signal received from the base station is supplied to either the information decoder or the energy harvester, each base station includes: a residual amount information obtaining unit which obtains residual amount information indicating a residual amount of stored power of the storage battery of each of the terminals; a grouping unit which groups the plurality of terminals into either an information transmission group that transmits information to be data or an energy harvesting group that charges the storage battery by energy harvesting based on each of the residual amount information obtained by the residual amount information obtaining unit and presence or absence of data to be transmitted to the terminals by the RF signal; and a control unit which controls bandwidth allocation and transmission power of the RF signal transmitted to each of the terminals for each group having been grouped by the grouping unit, and the centralized station includes: a collecting unit which collects terminal position information indicating a position of each of the terminals, power intensity information indicating an intensity of received power from each of the terminals, and residual amount information of the storage battery of each of the terminals via the plurality of base stations; an allocated power calculating unit which calculates allocated power with respect to each of the terminals of the base station based on the terminal position information, the power intensity information, and the residual amount information collected by the collecting unit; a parameter calculating unit which calculates, based on the allocated power calculated by the allocated power calculating unit, a parameter that optimizes bandwidth allocation and power use efficiency with respect to each of the terminals of the base station so as to minimize power consumption while raising the power use efficiency of the entire system; and a use efficiency control unit which controls use efficiency of transmitted power of the RF signal transmitted by each of the base stations to each of the terminals according to the parameter calculated by the parameter calculating unit.

A centralized station according to one embodiment of the present invention is a centralized station which centrally controls a plurality of base stations that each engage in multi-user MIMO wireless communication with a plurality of terminals, the centralized station comprising: a collecting unit which collects terminal position information indicating a position of each of the terminals, power intensity information indicating an intensity of received power from each of the terminals, and residual amount information indicating a residual amount of stored power of a storage battery of each of the terminals via the plurality of base stations; an allocated power calculating unit which calculates allocated power with respect to each of the terminals of the base station based on the terminal position information, the power intensity information, and the residual amount information collected by the collecting unit; a parameter calculating unit which calculates, based on the allocated power calculated by the allocated power calculating unit, a parameter that optimizes bandwidth allocation and power use efficiency with respect to each of the terminals of the base station so as to minimize power consumption while raising the power use efficiency of the entire system; and a use efficiency control unit which controls use efficiency of transmitted power of an RF signal transmitted by each of the base stations to each of the terminals according to the parameter calculated by the parameter calculating unit.

A centralized control method according to an embodiment of the present invention is a centralized control method of centrally controlling a plurality of base stations that each engage in multi-user MIMO wireless communication with a plurality of terminals, the centralized control method comprising: a collecting step of collecting terminal position information indicating a position of each of the terminals, power intensity information indicating an intensity of received power from each of the terminals, and residual amount information indicating a residual amount of stored power of the storage battery of each of the terminals via the plurality of base stations; an allocated power calculation step of calculating allocated power with respect to each of the terminals of the base station based on the collected terminal position information, the power intensity information, and the residual amount information; a parameter calculation step of calculating, based on the calculated allocated power, a parameter that optimizes bandwidth allocation and power use efficiency with respect to each of the terminals of the base station so as to minimize power consumption while raising the power use efficiency of the entire system; and a use efficiency control step of controlling use efficiency of transmitted power of an RF signal transmitted by each of the base stations to each of the terminals according to the calculated parameter.

### Advantageous Effect of the Invention

According to the present invention, use efficiency of power of an entire wireless communication system can be optimized while achieving both data transmission and energy harvesting by RF signals.

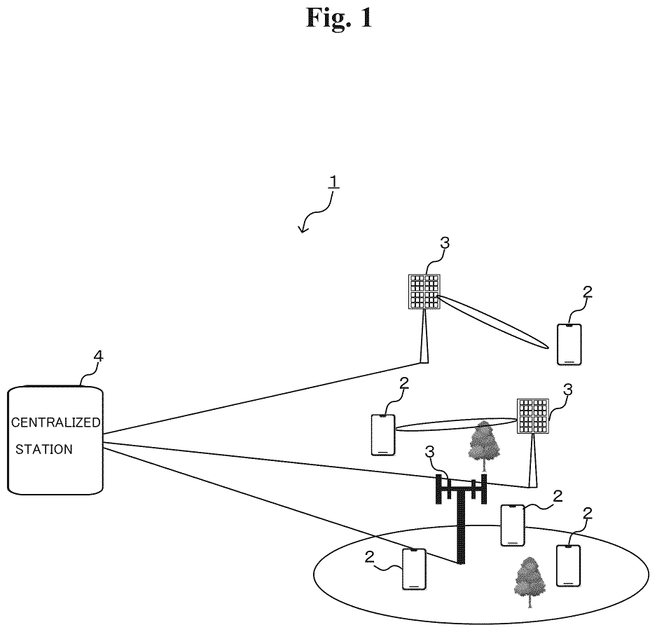

FIG. 1 is a diagram showing an outline of a wireless communication system according to the embodiment.

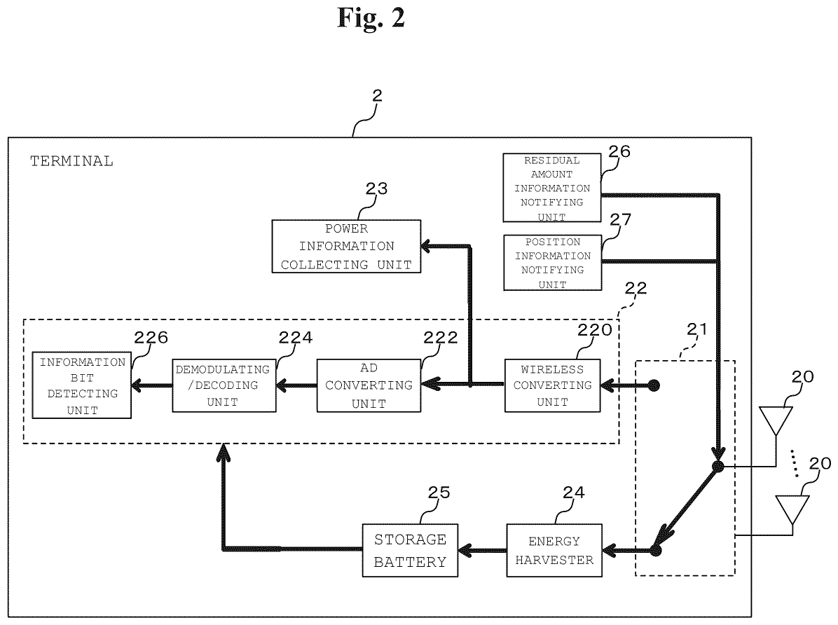

FIG. 2 is a functional block diagram illustrating functions of the terminal.

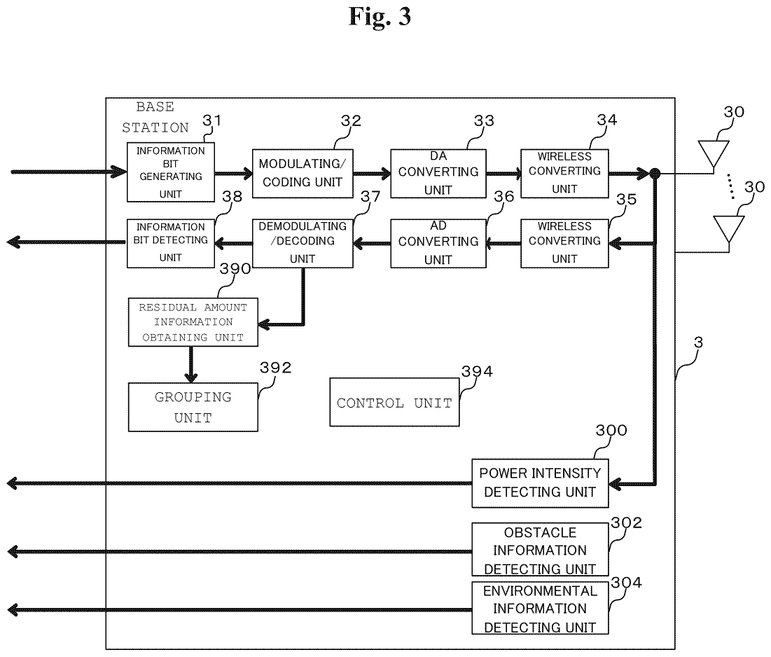

FIG. 3 is a functional block diagram illustrating functions of the base station.

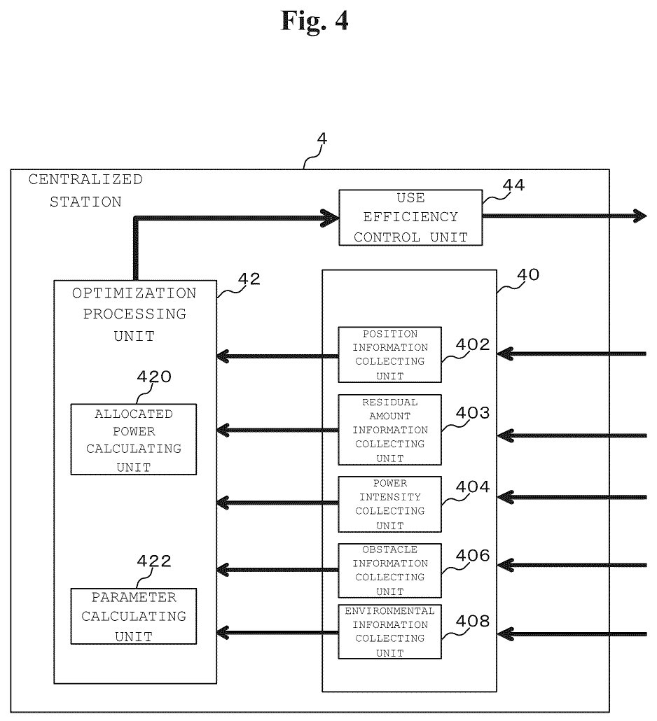

FIG. 4 is a functional block diagram illustrating functions of the centralized station.

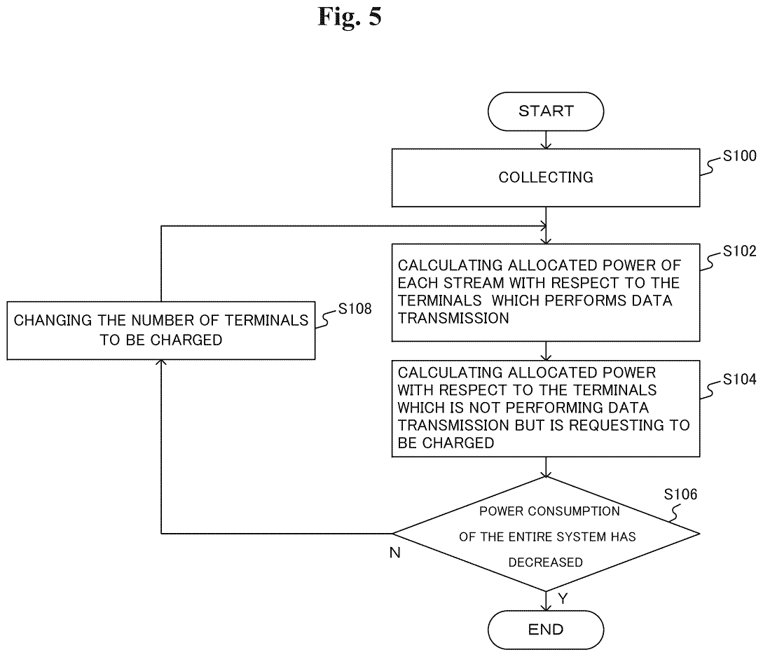

FIG. 5 is a flow chart showing an operation example of the centralized station.

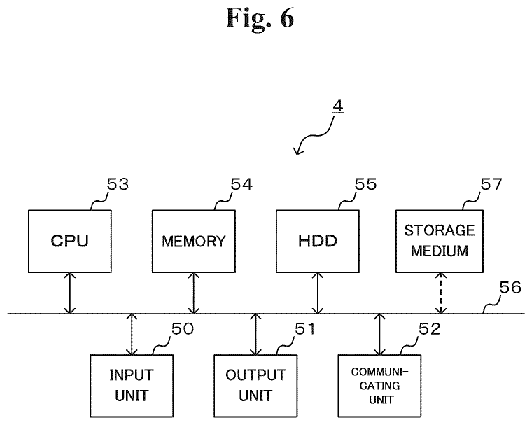

FIG. 6 is a diagram showing a configuration example of hardware included in the centralized station according to the embodiment.

### DESCRIPTION OF EMBODIMENT

Hereinafter, a wireless communication system according to one embodiment will be described with reference to the drawings. FIG. 1 is a diagram showing an outline of a wireless communication system 1 according to the embodiment. The wireless communication system 1 according to the embodiment includes a centralized station that centrally controls a plurality of base stations 3 that can each accommodate a plurality of terminals 2, and the pluralities of terminals 2 and base stations 3 engage in multi-user MIMO wireless communication.

Each terminal 2 is a wireless terminal that a user uses for wireless communication. Alternatively, the terminal 2 may be an IoT (Internet of Things) terminal or the like that only handles a small amount of communication data. Each base station 3 may be a reflector plate that relays radio waves. A centralized station 4 is configured to centrally control the plurality of base stations 3.

Next, functions of each of the terminals 2, the base stations 3, and the centralized station 4 will be described in detail using FIGS. 2 to 4.

FIG. 2 is a functional block diagram illustrating functions of the terminal 2. As shown in FIG. 2, for example, the terminal 2 includes a plurality of antennas 20, a switching unit 21, an information decoder 22, a power information collecting unit 23, an energy harvester 24, a storage battery 25, a residual amount information notifying unit 26, and a position information notifying unit 27.

The switching unit 21 performs switching so that an RF signal received from the base station 3 via the plurality of antennas 20, for example, is supplied to either the information decoder 22 or the energy harvester 24.

For example, the information decoder 22 includes a wireless converting unit 220, an AD converting unit 222, a demodulating/decoding unit 224, and an information bit detecting unit 226 and has a function of decoding information to be data from the RF signal received from the base station 3.

For example, the wireless converting unit 220 converts a wireless signal received via the plurality of antennas 20 into an analog signal with a predetermined frequency and outputs the analog signal to the AD converting unit 222 and the power information collecting unit 23.

The AD converting unit 222 is an analog-digital converting unit that converts the analog signal converted by the wireless converting unit 220 into a digital signal.

The demodulating/decoding unit 224 demodulates reception data having been converted into a digital signal by the AD converting unit 222, performs error correction decoding, and outputs the resultant signal to the information bit detecting unit 226.

The information bit detecting unit 226 detects an information bit from the signal inputted from the demodulating/decoding unit 224.

The power information collecting unit 23 collects power information of the received signal inputted to the information decoder 22.

The energy harvester 24 performs a charge of the storage battery 25 by energy harvesting using the RF signal received from the base station 3.

The storage battery 25 is charged by the energy harvester 24 or the like and supplies power to each unit constituting the terminal 2.

The residual amount information notifying unit 26 performs processing of notifying the base station 3 of residual amount information indicating a residual amount of stored power of the storage battery 25.

The position information notifying unit 27 generates a notification signal for notifying the base station 3 of information (terminal position information) indicating a position of its own station (the terminal 2) and notifies the base station 3 of the generated notification signal via the antenna 20.

FIG. 3 is a functional block diagram illustrating functions of the base station 3. As shown in FIG. 3, for example, the base station 3 includes a plurality of antennas 30, an information bit generating unit 31, a modulating/coding unit 32, a DA converting unit 33, a wireless converting unit 34, a wireless converting unit 35, an AD converting unit 36, a demodulating/decoding unit 37, an information bit detecting unit 38, a power intensity detecting unit 300, an obstacle information detecting unit 302, an environmental information detecting unit 304, a residual amount information obtaining unit 390, a grouping unit 392, and a control unit 394.

The information bit generating unit 31 generates an information bit indicating data and the like to be transmitted to the terminal 2 and outputs the generated information bit to the modulating/coding unit 32.

The modulating/coding unit 32 subjects the information bit generated by the information bit generating unit 31 to error correction coding, digitally modulates the coded information bit into a data signal, and outputs the data signal to the DA converting unit 33.

The DA converting unit 33 converts the data signal having been digitally-modulated by the modulating/coding unit 32 into an analog signal and outputs the analog signal to the wireless converting unit 34.

The wireless converting unit 34 converts the analog signal converted by the DA converting unit 33 into a predetermined wireless signal and transmits the wireless signal via the plurality of antennas 30.

The wireless converting unit 35 converts the wireless signal received via the plurality of antennas 30 into an analog signal with a predetermined frequency and outputs the analog signal to the AD converting unit 36.

The AD converting unit 36 is an analog-digital converting unit that converts the analog signal converted by the wireless converting unit 35 into a digital signal.

The demodulating/decoding unit 37 demodulates reception data having been converted into a digital signal by the AD converting unit 36, performs error correction decoding, and outputs the resultant signal to the information bit detecting unit 38 and the residual amount information obtaining unit 390.

The information bit detecting unit 38 detects an information bit from the signal inputted from the demodulating/decoding unit 37.

The power intensity detecting unit 300 performs processing of detecting intensity of power of a signal received from each of the terminals 2 via the plurality of antennas 30 and notifying the centralized station 4 of the detected intensity. For example, the power intensity detecting unit 300 detects a gain of each multipath for each delay time. In addition, the power intensity detecting unit 300 may have a function of detecting a distance to and from the terminal 2, a propagation loss to and from the terminal 2, and the like.

The obstacle information detecting unit 302 is an image sensor such as a CMOS sensor that detects an obstacle that affects communication with the terminal 2 and performs processing of notifying the centralized station 4 of information indicating the detected obstacle. For example, the obstacle information detecting unit 302 photographs an object positioned between each of the terminals 2 and itself.

The environmental information detecting unit 304 performs processing of detecting a peripheral environment that affects communication with the terminal 2 and notifying the centralized station 4 of environmental information indicating the detected peripheral environment.

The residual amount information obtaining unit 390 obtains each piece of residual amount information indicating a residual amount of stored power of the storage battery 25 of each of the terminals 2 and outputs the residual amount information to the grouping unit 392.

Based on each of the residual amount information obtained by the residual amount information obtaining unit 390 and the presence or absence of data to be transmitted to the terminal 2 by an RF signal, the grouping unit 392 groups the plurality of terminals 2 so that each terminal 2 belongs to either an information transmission group that transmits information to be data or an energy harvesting group that charges the storage battery 25 by energy harvesting.

The control unit 394 controls each unit which constitutes the base station 3. For example, the control unit 394 controls bandwidth allocation and transmission power of RF signals transmitted to each of the terminals 2 for each group having been grouped by the grouping unit 392.

In addition, for example, the base station 3 is configured to have a function of transmitting, to the centralized station 4, a wireless quality status (propagation loss, fading environment, or shadowing) between the terminal 2 and the base station 3, terminal position information indicating a position of the terminal 2 having been notified by the terminal 2, and the like.

FIG. 4 is a functional block diagram illustrating functions of the centralized station 4. As shown in FIG. 4, for example, the centralized station 4 includes a collecting unit 40, an optimization processing unit 42, and a use efficiency control unit 44.

For example, the collecting unit 40 includes a position information collecting unit 402, a residual amount information collecting unit 403, a power intensity collecting unit 404, an obstacle information collecting unit 406, and an environmental information collecting unit 408. In addition, the collecting unit 40 collects terminal position information indicating a position of each of the terminals 2, power intensity information indicating an intensity of received power from each of the terminals 2, and residual amount information of the storage battery 25 of each of the terminals 2 via the plurality of base stations 3 and outputs the collected information to the optimization processing unit 42.

For example, the position information collecting unit 402 collects terminal position information indicating a position of each of the terminals 2 that is transmitted from the base station 3 and outputs the terminal position information to the optimization processing unit 42.

The residual amount information collecting unit 403 collects residual amount information of the storage battery 25 of each of the terminals 2 that is transmitted from the base station 3 and outputs the residual amount information to the optimization processing unit 42.

The power intensity collecting unit 404 collects power information indicating an intensity of received power from each of the terminals 2 that is transmitted from the base station 3 and outputs the power information to the optimization processing unit 42.

The obstacle information collecting unit 406 collects information indicating an obstacle that affects communication with the terminal 2 that is transmitted from the base station 3 and outputs the information to the optimization processing unit 42.

The environmental information collecting unit 408 collects environmental information indicating a peripheral environment that affects communication with the terminal 2 that is transmitted from the base station 3 and outputs the environmental information to the optimization processing unit 42.

The optimization processing unit 42 includes an allocated power calculating unit 420 and a parameter calculating unit 422, performs processing of optimizing use efficiency of power of the entire wireless communication system 1, and outputs a processing result to the use efficiency control unit 44.

For example, the allocated power calculating unit 420 calculates allocated power with respect to each of the terminals 2 of the base station 3 based on the terminal position information, the power intensity information, and the residual amount information collected by the collecting unit 40 and outputs the calculated allocated power to the parameter calculating unit 422.

Based on the allocated power calculated by the allocated power calculating unit 420, the parameter calculating unit 422 calculates a parameter that optimizes bandwidth allocation and power use efficiency with respect to each of the terminals 2 of the base station 3 so as to minimize power consumption while raising the power use efficiency of the entire system and outputs the parameter to the use efficiency control unit 44.

For example, the parameter calculating unit 422 calculates the parameter that optimizes bandwidth allocation and power use efficiency with respect to each of the terminals 2 of the base station 3 by changing the number of the terminals 2 that belong to the energy harvesting group so as to minimize the power consumption of the entire system.

The use efficiency control unit 44 controls each of the base stations 3 so as to control use efficiency of transmitted power of the RF signal transmitted by each of the base stations 3 to each of the terminals 2 according to the parameter calculated by the parameter calculating unit 422.

Next, an operation example of the centralized station 4 will be described. FIG. 5 is a flow chart showing an operation example of the centralized station 4. As shown in FIG. 5, for example, the centralized station 4 collects terminal position information, power intensity information, and residual amount information of each of the terminals 2 (S100).

Next, based on the collected terminal position information, the power intensity information, and the residual amount information of each of the terminals 2, the centralized station 4 calculates allocated power of each stream of multi-user MIMO with respect to each of the terminals 2 which performs data transmission (S102).

Next, based on the collected terminal position information, the power intensity information, and the residual amount information of each of the terminals 2, the centralized station 4 calculates allocated power with respect to each of the terminals 2 which is not performing data transmission but is requesting to be charged (S104).

In addition, the centralized station 4 determines whether or not power consumption of the entire wireless communication system 1 has decreased (S106), and when the power consumption of the entire wireless communication system 1 has decreased (S106: Yes), the centralized station 4 ends processing, but otherwise (S106: No), the centralized station 4 advances to processing of S108.

In the processing of S108, the centralized station 4 changes the number of terminals to be charged by energy harvesting and returns to the processing of S102.

As described above, since the wireless communication system 1 according to the embodiment controls use efficiency of transmitted power of an RF signal transmitted by each of the base stations 3 to each of the terminals 2 according to a parameter calculated by collecting terminal position information, power intensity information, and residual amount information of the storage battery 25 of each of the terminals 2, the wireless communication system 1 according to the embodiment enables use efficiency of power of the entire wireless communication system to be optimized while achieving both data transmission and energy harvesting by the RF signals.

Note that each function of the terminals 2, the base stations 3, and the centralized station 4 may be partially or entirely constituted of hardware such as a PLD (Programmable Logic Device) or an FPGA (Field Programmable Gate Array) or configured as a program to be executed by a processor such as a CPU.

For example, the centralized station 4 can be realized using a computer and a program and the program can be either recorded in a storage medium or provided through a network.

FIG. 6 is a diagram showing a configuration example of hardware included in the centralized station 4 according to the embodiment. As shown in FIG. 6, in the centralized station 4, an input unit 50, an output unit 51, a communicating unit 52, a CPU 53, a memory 54, and an HDD 55 are connected via bus 56 and the centralized station 4 functions as a computer. In addition, the centralized station 4 is configured to be capable of inputting and outputting data to and from a computer-readable storage medium 57.

The input unit 50 is, for example, a keyboard and a mouse or the like. The output unit 51 is, for example, a display apparatus such as a display. In addition, the input unit 50 and the output unit 51 may be a touch panel or the like.

The communicating unit 52 is, for example, a communication interface that performs wireless communication.

The CPU 53 controls the various units that constitute the centralized station 4 and performs predetermined processing and the like. The memory 54 and the HDD 55 store data and the like.

The storage medium 57 is configured to be capable of storing a program and the like that causes functions of the centralized station 4 to be executed. Note that an architecture constituting the centralized station 4 is not limited to the example shown in FIG. 6.

### REFERENCE SIGNS LIST

1 Wireless communication system
2 Terminal
3 Base station
4 Centralized station
20 Antenna
21 Switching unit
22 Information decoder
23 Power information collecting unit
24 Energy harvester
25 Storage battery
26 Residual amount information notifying unit
27 Position information notifying unit
30 Antenna
31 Information bit generating unit
32 Modulating/coding unit
33 DA converting unit
34 Wireless converting unit
35 Wireless converting unit
36 AD converting unit
37 Demodulating/decoding unit
38 Information bit detecting unit
40 Collecting unit
42 Optimization processing unit
44 Use efficiency control unit
50 Input unit
51 Output unit
52 Communicating unit
53 CPU
54 Memory
55 HDD
56 Bus
57 Storage medium
220 Wireless converting unit
222 AD converting unit
224 Demodulating/decoding unit
226 Information bit detecting unit
300 Power intensity detecting unit
302 Obstacle information detecting unit
304 Environmental information detecting unit
390 Residual amount information obtaining unit
392 Grouping unit
394 Control unit
402 Position information collecting unit
403 Residual amount information collecting unit
404 Power intensity collecting unit
406 Obstacle information collecting unit
408 Environmental information collecting unit
420 Allocated power calculating unit
422 Parameter calculating unit

1. A wireless communication system comprising a centralized station which centrally controls a plurality of base stations that can each accommodate a plurality of terminals, the pluralities of terminals and base stations engaging in multi-user MIMO wireless communication, wherein
each terminal includes:
an information decoder which decodes information to be data from an RF signal received from each base station;
an energy harvester which performs a charge of a storage battery by energy harvesting using the RF signal received from the base station; and
switching circuitry configured to perform switching so that the RF signal received from the base station is supplied to either the information decoder or the energy harvester,
each base station includes:
residual amount information obtaining circuitry configured to obtain residual amount information indicating a residual amount of stored power of the storage battery of each of the terminals;
grouping circuitry configured to group the plurality of terminals into either an information transmission group that transmits information to be data or an energy harvesting group that charges the storage battery by energy harvesting based on each of the residual amount information obtained by the residual amount information obtaining circuitry and presence or absence of data to be transmitted to the terminals by the RF signal; and
control circuitry configured to control bandwidth allocation and transmission power of the RF signal transmitted to each of the terminals for each group having been grouped by the grouping circuitry, and
the centralized station includes:
collecting circuitry configured to collect terminal position information indicating a position of each of the terminals, power intensity information indicating an intensity of received power from each of the terminals, and residual amount information of the storage battery of each of the terminals via the plurality of base stations;
allocated power calculating circuitry configured to calculate allocated power with respect to each of the terminals of the base station based on the terminal position information, the power intensity information, and the residual amount information collected by the collecting circuitry;
parameter calculating circuitry configured to calculate, based on the allocated power calculated by the allocated power calculating circuitry, a parameter that optimizes bandwidth allocation and power use efficiency with respect to each of the terminals of the base station so as to minimize power consumption while raising the power use efficiency of the entire system; and
use efficiency control circuitry configured to control use efficiency of transmitted power of the RF signal transmitted by each of the base stations to each of the terminals according to the parameter calculated by the parameter calculating circuitry.

2. The wireless communication system according to claim 1, wherein
the parameter calculating circuitry
calculate the parameter that optimizes bandwidth allocation and power use efficiency with respect to each of the terminals of the base station by changing the number of the terminals that belong to the energy harvesting group so as to minimize the power consumption of the entire system.

3. A centralized station which centrally controls a plurality of base stations that each engage in multi-user MIMO wireless communication with a plurality of terminals, the centralized station comprising:
collecting circuitry configured to collect terminal position information indicating a position of each of the terminals, power intensity information indicating an intensity of received power from each of the terminals, and residual amount information indicating a residual amount of stored power of a storage battery of each of the terminals via the plurality of base stations;
allocated power calculating circuitry configured to calculate allocated power with respect to each of the terminals of the base station based on the terminal position information, the power intensity information, and the residual amount information collected by the collecting circuitry;
parameter calculating circuitry configured to calculate, based on the allocated power calculated by the allocated power calculating circuitry, a parameter that optimizes bandwidth allocation and power use efficiency with respect to each of the terminals of the base station so as to minimize power consumption while raising the power use efficiency of the entire system; and
use efficiency control circuitry configured to control use efficiency of transmitted power of an RF signal transmitted by each of the base stations to each of the terminals according to the parameter calculated by the parameter calculating circuitry.

4. The centralized station according to claim 3, wherein
the parameter calculating circuitry
calculate the parameter that optimizes bandwidth allocation and power use efficiency with respect to each of the terminals of the base station by changing the number of the terminals that belong to an energy harvesting group which performs a charge to a storage battery by energy harvesting without receiving information to be data by the RF signal received from the base station so as to minimize the power consumption of the entire system.

5. A centralized control method of centrally controlling a plurality of base stations that each engage in multi-user MIMO wireless communication with a plurality of terminals, the centralized control method comprising:
collecting terminal position information indicating a position of each of the terminals, power intensity information indicating an intensity of received power from each of the terminals, and residual amount information indicating a residual amount of stored power of the storage battery of each of the terminals via the plurality of base stations;
calculating allocated power with respect to each of the terminals of the base station based on the collected terminal position information, the power intensity information, and the residual amount information;
calculating, based on the calculated allocated power, a parameter that optimizes bandwidth allocation and power use efficiency with respect to each of the terminals of the base station so as to minimize power consumption while raising the power use efficiency of the entire system; and
controlling use efficiency of transmitted power of an RF signal transmitted by each of the base stations to each of the terminals according to the calculated parameter.

6. The centralized control method according to claim 5, wherein
in parameter calculating,
the parameter that optimizes bandwidth allocation and power use efficiency with respect to each of the terminals of the base station is calculated by changing the number of the terminals that belong to an energy harvesting group which performs a charge to the storage battery by energy harvesting without receiving information to be data by the RF signal received from the base station so as to minimize the power consumption of the entire system.

7. A non-transitory computer-readable storage medium storing a centralized control program which causes a computer to function as each circuitry of the centralized station according to claim 3.
